(19) United States
(12) Patent Application Publication
(10) Pub. No.: US 2022/0139291 A1
(43) Pub. Date: May 5, 2022

(54) METHOD, SYSTEM TO COMPENSATE FOR MURA EFFECTS IN DISPLAY PANEL, AND ELECTRONIC DEVICE

(71) Applicants: HONG FU TAI PRECISION ELECTRONS (YANTAI) CO., LTD., Yantai (CN); HON HAI PRECISION INDUSTRY CO., LTD., New Taipei (TW)

(72) Inventors: YAN-NI ZHANG, Yantai (CN); HUI ZHANG, Yantai (CN)

(21) Appl. No.: 17/458,933

(22) Filed: Aug. 27, 2021

(30) Foreign Application Priority Data
Nov. 2, 2020 (CN) 202011202654.4

(51) Int. Cl. G09G 3/20; G06K 9/62; G06T 7/13; G06T 5/00; G06T 5/20

(52) U.S. Cl. CPC G09G 3/2074; G06K 9/6202; G06T 7/13; G06T 5/005; G06T 5/20; G09G 2360/16; G09G 2320/0233; G06T 2207/20028; G06T 2207/20032; G09G 2300/0443; G09G 2320/0686; G09G 2320/0673

(57) ABSTRACT

A method for applying compensation to a display screen to reduce MURA effects in the display includes: collecting a display image of the display panel and obtaining panel parameters, the panel parameters comprising a greyscale level values and a luminance value of each pixel in the display image. Regions containing a foreign object are recognized and removed, the blanked regions being infilled. A Gramma value of the display panel is calculated according to the panel parameters and a Gamma curve determined, luminance value of each region of the display panel being obtained according to the Gamma curve. An ideal quadric surface for the display panel is obtained according to the luminance value of each region, a compensation parameter is calculated according to the ideal quadric surface, and compensation applied accordingly. A system and electronic device are also disclosed.

### CROSS-REFERENCE TO RELATED APPLICATIONS

This application claims priority to Chinese Patent Application No. 202011202654.4 filed on Nov. 2, 2020 in China National Intellectual Property Administration, the contents of which are incorporated by reference herein.

### FIELD

The subject matter herein generally relates to display technology field.

### BACKGROUND

During a production process of a planar display panel, the manufacturing process or electrical characteristics of components, and other factors, may cause a phenomenon of unevenness in picture display (Mura effect), which is problematic.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of an electronic device according to the present disclosure.

FIG. 2 is a diagram of an embodiment of a Mura-effect compensation system for display panel device according to the present disclosure.

FIG. 3 is a flowchart of an embodiment of a method for compensating against a Mura effect in a display panel device according to the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

In order to offset the Mura effect and improve a quality of picture, panel parameters are usually compensated for during the production process, which is called De-Mura. A basic principle of De-Mura technology is to take the panel display as a gray scale picture, shoot the screen with capacitive coupler, obtain luminance values of each pixel in the panel, and then adjust the gray value or a voltage of the pixel in the Mura region, so that a dark region becomes brighter and a bright region becomes darker, to achieve a uniform display effect with no unevenness.

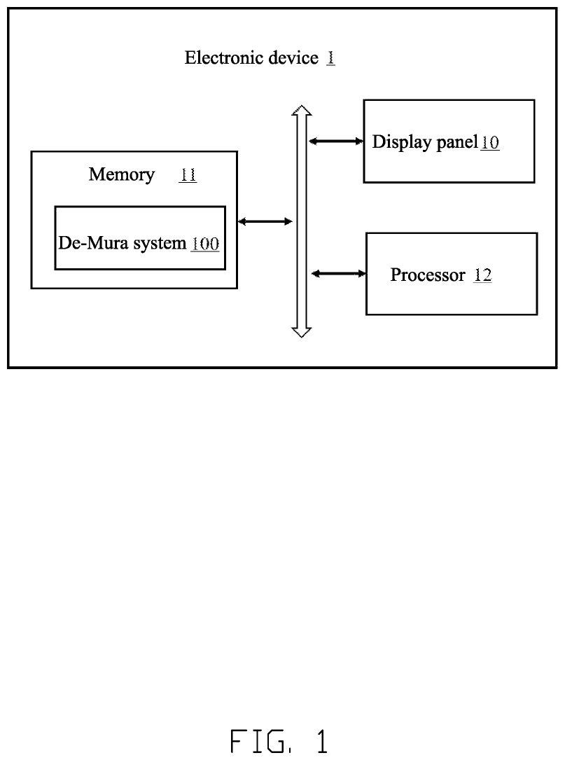

FIG. 1 illustrates a schematic diagram of an embodiment of an electronic device 1.

In at least one embodiment, the electronic device 1 includes a display panel 10, a memory 11, and at least one processor 12.

In other embodiments, other examples of the electronic device 1 can include more or less hardware or software than that shown in FIG. 1 or have different component arrangements.

In some embodiments, the display panel 10 can be an Organic Light Emitting Diode (OLED) display panel or a Quantum Dot Light Emitting Diode (QLED).

In some embodiments, the memory 11 is used to store program codes and various data of a computer program. For instance, the memory 11 can be used to store a De-Mura system 100 for display panel (for convenience of description, hereinafter “De-Mura system 100”) installed in the electronic device 1. The memory 11 can also implement programs or data during an operation of the electronic device 1.

The memory 11 can be a non-volatile computer storage medium including a

Read-Only Memory (ROM), a Programmable Read-Only Memory (PROM), an Erasable Programmable Read-Only Memory (EPROM), a One-time Programmable Read-Only Memory (OTPROM), an Electrically Erasable Programmable Read-Only Memory (EEPROM), an optical Read-Only disk (CD-ROM) or other optical disk storage, a magnetic disk storage, a tape storage, or any other non-volatile computer storage medium capable of carrying or storing data.

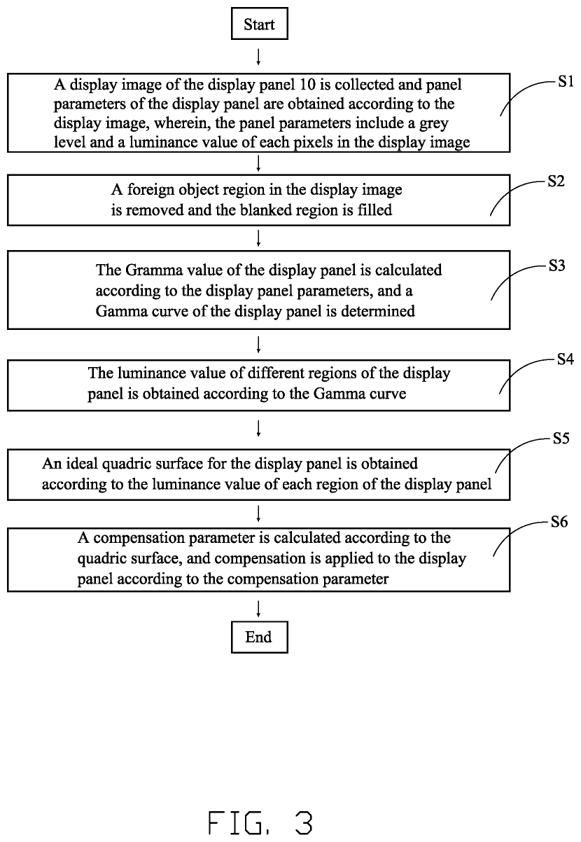

In some embodiments, the at least one processor 12 can be formed by integrated circuits. For instance, the at least one processor 12 can be formed by a single packaged integrated circuit, or can be formed by a plurality of integrated circuits packaged with the same function or different functions. The at least one processor 12 includes one or more Central Processing Units (CPUs), microprocessors, digital Processing chips, graphics processors, and combinations of various control chips. The at least one processor 12 is a control unit of the electronic device 1, connecting various components of the electronic device 1 by various interfaces and lines, performing various functions and data processes of the electronic device 1 by executing programs, modules, or instructions stored in the memory 11, and invoking data stored in the memory 11. In this embodiment, the various functions and data processes of the electronic device 1 can include De-Mura function of display panel, shown in FIG. 3.

In some embodiments, the De-Mura system 100 can include one or more modules. The one or more modules are stored in the memory 11, and executed by at least one or more processors (for example, the processor 12), to achieve the De-Mura function of display panel (See FIG. 3 for detail).

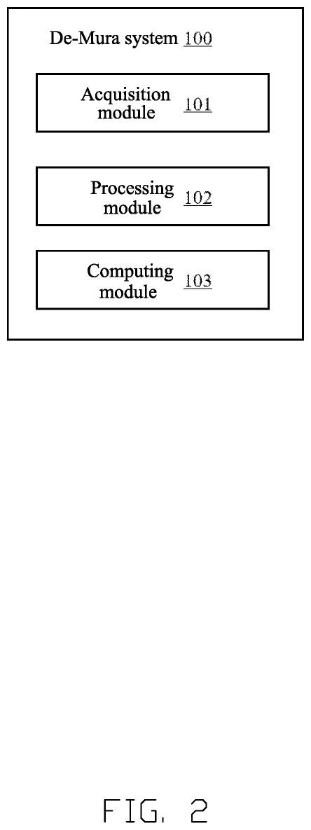

In some embodiments, the De-Mura system 100 can be divided into multiple modules by the functions performed. As shown in FIG. 2, the multiple modules include an acquisition module 101, a processing module 102, and a computing module 103. In this embodiment, the modules referred to herein are a series of computer-readable instructions, capable of being executed by at least one processor (such as the processor 12), and capable of performing fixed functions. The modules are stored in a memory, such as the memory 11 of the electronic device 1.

The acquisition module 101 is configured to acquire a display image of the display panel and obtain panel parameters of the display panel according to the display image. In this embodiment, the panel parameters include a gray value and a luminance value of each pixel in the display image.

The processing module 102 is configured to remove a region of foreign object in the display image and infill the blanked region.

The computing module 103 is configured to calculate a Gamma value of the display panel according to the panel parameters, and determine a Gamma curve of the display panel.

The processing module 102 is further configured to obtain the luminance value of each region of the display panel according to the Gamma curve, and obtain an ideal quadric surface displayed by the display panel according to the luminance value of each region of the display panel. The computing module 103 is further configured to calculate a parameter for compensation according to the quadric surface, and apply compensation to the display panel based on the compensation parameter.

In some embodiments, integrated units formed by software functional modules can be stored in a non-volatile readable storage medium. The software functional modules include one or more computer readable instructions. The electronic device 1 or the at least one processor 12 implements part of the method of the present disclosure, for instance, the De-Mura method of the display panel shown in FIG. 3.

In some embodiments, FIG. 2 shows that the at least one processor 12 can execute program codes, various types of applications (for instance, the De-Mura system 100) installed in the electronic device 1.

In some embodiments, the memory 11 stores program codes for computer programs, and the at least one processor 12 can call up the program codes stored in the memory 11 to perform related functions. For instance, the modules of the De-Mura system 100 in FIG. 2 are program codes stored in the memory 11 and executed by the at least one processor 12 to realize the functions of the modules for achieving the purpose of De-Mura compensation applied to the display panel (See FIG. 3 for detail).

In some embodiments, the memory 11 stores one or more computer readable instructions. The one or more computer readable instructions are executed by the at least one processor 12 to achieve the purpose of the De-Mura function of the display panel. Specifically, the at least one processor 12 can implement the above-mentioned computer readable instructions in a manner described below, referring to FIG. 3.

FIG. 3 illustrates a flowchart of a method to apply De-Mura process to a display panel (“De-Mura method”). The embodiment is provided by way of example, as there are a variety of ways to carry out the method. The method described below can be carried out using the configurations illustrated in FIGS. 1-2, for example, and various elements of these figures are referenced in explaining the embodiment. Each block shown in FIG. 3 represents one or more processes, methods, or subroutines carried out in the embodiment. Furthermore, the illustrated order of blocks is by example only, and the order of the blocks can be changed. Additional blocks can be added or fewer blocks can be utilized, without departing from this disclosure. The embodiment can begin at block S1.

In some embodiments, the De-Mura method can be applied to the electronic device 1, for the display panel requiring De-Mura compensation. The function for De-Mura method provided by the present disclosure can be directly integrated on the electronic device 1, or can be run on the electronic device 1 in the form of a Software Development Kit (SDK).

At block S1, a display image of the display panel 10 is collected and panel parameters of the display panel are obtained according to the display image.

In block S1, the panel parameters include a grey level and a luminance value of each pixel in the display image.

In block S1, the display image of the display panel 10 during a display process can be captured by a high-definition camera (such as CCD). The panel parameters of the display panel can be obtained according to the display image, so as to provide data for the De-Mura method process.

In block S1, the panel parameters include a grey scale of the display panel and the grey level and the luminance value of the display image. The luminance value includes a maximum luminance value of the display panel and a minimum luminance value of the display panel.

At block S2, a foreign object region in the display image is removed and the blanked region is filled.

For the purposes of block S2, foreign object can be attached to the display panel from the external environment during the production process of the display panel. In this case, if the De-Mura process is directly performed on the display image when it includes the foreign object and the foreign object region is removed after the De-Mura process, a bright spot can be present in the display image after the foreign object region is removed, resulting in poor visual perception of the product, or many defective products.

In some embodiments, when a foreign object is present on the display panel, it is necessary to process the display image including the foreign object. For example, the foreign object is identified and then excavated or removed, and then the excavated region is repaired. Thus, when the De-Mura adjustment is subsequently performed, the risk of white spots in the display panel can be avoided.

In other embodiments, before the foreign object region in the display image is removed and the blanked region is filled, the method further includes:

Determining whether foreign object exists on the display panel according to the panel parameters. If the foreign object exists on the display panel, the foreign object region in the display image is removed and the blanked region is filled.

Specifically, the method of determining whether foreign object exists includes:

Detecting the grey level of every sub-pixel of the display image.

Comparing the grey level of every sub-pixel with the grey level of at least two adjacent sub-pixels.

Determining whether a difference of the grey levels between the sub-pixel and the adjacent sub-pixels reaches a preset threshold value. If the difference of the grey level between the sub-pixel and the adjacent sub-pixels reaches the preset threshold value, the foreign object is determined to exist on the display panel. If the difference of grey level between the sub-pixel and the adjacent sub-pixels does not reach the preset threshold value, absence of the foreign object is determined.

In this embodiment, block S2 further includes:

Obtaining an image edge of the foreign object image according to an edge detection algorithm.

Obtaining a foreign object rectangular map by scanning the foreign object image according to a minimum enclosing rectangle algorithm.

Removing the pixel in the foreign object rectangular map and obtaining a blank region.

Compensating for the blank region by a linear interpolation.

In some embodiments, before block S2, the method also includes:

Filtering an image through an image processing technology to remove noise of the image. In this embodiment, the filtering method can be, but not limited to, any one of a median filtering, a mean filtering, a Gaussian filtering, and a bilateral filtering. By performing the filtering, the influence of noise can be eliminated. In some embodiments, the median filtering or the mean filtering is applied to the image as the filtering process.

In block S2, the influence of the foreign object on the panel display is considered. By removing the foreign object region and compensating for the blank region after the foreign object region is removed, the influence of the foreign object region on the adjustment of the brightness uniformity of the display panel is reduced to zero. Interference of the foreign object on the image is avoided, and the full effect of the De-Mura method can be applied.

At block S3, the Gramma value of the display panel is calculated according to the display panel parameters, and a Gamma curve of the display panel is determined.

In some embodiments, the Gramma value of the display panel can be calculated by a Gamma curve formula (formula (1)).

$$L = ( {L}_{max} - {L}_{min} ) \times {( GL )}^{Gamma} + {L}_{min} \qquad ( formula ( 1 ) )$$

In formula (1), L represents a luminance value of the display panel at grey scale GL, Lₘₐₓ is the maximum luminance value of the display panel, and Lₘᵢₙ is the minimum luminance value of the display panel.

In block S3, the display panel can display different degrees of luminance value from dark to bright. In order to display from dark to bright, different data needs to be input. The data are divided into N segments equally from small to large, each segment is one segment. For example, a first segment is called a first order, the i-th segment is called an i-th order, which can be written as GLᵢ. Then, through selecting three different points from the grey scale GLᵢ and substituting the three different points into the formula (1), then the Gamma value is obtained.

At block S4, the luminance value of different regions of the display panel is obtained according to the Gamma curve.

In block S4, a different grey scale corresponds to a different luminance, the gray scale and the luminance are placed in two-dimensional coordinates, and a curve can be drawn, which is called the Gamma curve, such as the curve equation described in the above formula (1). In this embodiment, an exponent of the curve equation is the Gamma value. Once the Gamma value is confirmed, a luminance value of a certain grey scale can be calculated, thus the luminance value of each region of the display panel is obtained.

In this embodiment, the luminance value determined according to the Gamma curve is the luminance of each region in the display panel. That is, the display panel is divided into many different regions, and the luminance of each region may be different.

In some embodiments, the luminance value of each sub-pixel at the gray scale of the panel can be obtained by a luminance obtaining device. The luminance obtaining device includes, but is not limited to, a Charge Coupled Device (CCD) camera. The CCD camera captures the image information of the display panel under the gray scale, and then the luminance value is obtained according to the image information.

At block S5, an ideal quadric surface for the display panel is obtained according to the luminance value of each region of the display panel.

In block S5, the ideal quadric surface is taken as an ideal target surface. In this embodiment, an equation of the ideal quadric surface is formula (2).

$$L = ( {C}_{1} {X}^{2} + {C}_{2} {Y}^{2} ) + {C}_{2} \qquad ( formula ( 2 ) )$$

In formula (2), L is the luminance value of the display panel. C1, C2, and C3 are variable coefficients and can be adjusted according to a condition of the display panel. X and Y are two variables of the quadric equation, which can be understood as the length and width of the display panel 10.

At block S6, a compensation parameter is calculated according to the quadric surface, and compensation is applied to the display panel according to the compensation parameter.

In block S6, the ideal target surface L(x, y) and the original data S(x, y) of the display panel can be calculated according to the quadric surface, then the compensation parameter P (x, y) is calculated. For instance, the compensation parameter can be calculated through the following formula (3).

$$P ( x , y ) = C 1 \times ( T ( x , y ) - S ( x , y ) ) + C 2 \qquad ( formula ( 3 ) )$$

In formula (3), T(x,y) is a target data obtained according to the quadric surface, which can be considered as grey scale. S(x,y) is a grey scale parameter obtained by converting the display image from which the foreign object region is removed. Specifically, compensation can be applied to the display panel 10 by inputting the compensation parameter to the display panel 10 for displaying. At this time, compensation parameters are superimposed onto the defective display panel to obtain the gray scale displayed by the display panel 10.

In some embodiments, after the compensation parameters are obtained through calculation, the compensation parameters may be converted into a De-Mura table according to formula (4). The De-Mura table may be written into Flash and then input to the display panel 10 for display.

$${\sum }_{y = 0}^{h} {\sum }_{x = 0}^{w} T ( x , y ) = {\sum }_{y = 0}^{h} {\sum }_{x = 0}^{w} [ P 1 ( x , y ) + P 2 ( x , y ) + P 3 ( x , y ) + P 4 ( x , y ) + P 5 ( x , y ) ] \qquad ( formula ( 4 ) )$$

The present disclosure can work out a perfect quadric surface as an ideal target surface according to the collected luminance data and correct the display luminance of the entire plane/curved surface display panel in a luminance compensation mode. The display effect of the display panel is improved, uniformity of picture luminance is improved, transition from middle luminance to peripheral luminance is optimized, comfort of human eyes is enhanced, and abrupt phenomena of vision caused by obvious bright-dark contrast are reduced.

The disclosure also includes foreign object recognition and removal function before De-Mura process, to avoid applying an incorrect De-Mura method in relation to foreign object.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A Mura compensation method of a display panel, the Mura compensation method comprising:
collecting a display image of the display panel and obtaining panel parameters of the display panel according to the display image, the panel parameters comprise a grey level and a luminance value of each pixel in the display image;
removing a foreign object region in the display image and filling the removed region;
calculating a Gramma value of the display panel according to the panel parameters and determining a Gamma curve of the display panel;
obtaining a luminance value of each region of the display panel according to the Gamma curve;
obtaining an ideal quadric surface for the display panel according to the luminance value of each region of the display panel;
calculating a compensation parameter according to the ideal quadric surface, and compensating the display panel according to the compensation parameter.

2. The Mura compensation method of claim 1, further comprising:
determining whether there exists foreign object in the display panel according to the panel parameter.

3. The Mura compensation method of claim 2, wherein the step of determining whether there exist foreign object in the display panel according to the panel parameter comprises:
detecting the grey level of every sub-pixel of the display image;
comparing the grey level of every sub-pixel with the grey level of at least two adjacent sub-pixel;
determining whether the difference of the grey level between the sub-pixel and the at least two adjacent sub-pixel reaches a preset threshold, wherein
if the difference of the grey level between the sub-pixel and the at least two adjacent sub-pixel reaches the preset threshold value, the foreign object is determined to exist on the display panel; and
if the difference of the grey level between the sub-pixel and the at least two adjacent sub-pixel does not reach the preset threshold value, the foreign object is determined to not exist on the display panel.

4. The Mura compensation method of claim 1, wherein the step of removing a foreign object region in the display image and filling the removed region further comprises:
obtaining an image edge of the foreign object image according to an edge detection algorithm;
obtaining a foreign object rectangular map by scanning the foreign object image according to a minimum enclosing rectangle algorithm;
removing the pixel in the foreign object rectangular map and obtaining a blank region;
compensating the blank region by a linear interpolation.

5. The Mura compensation method of claim 4, wherein before the step of removing a foreign object region in the display image and filling the removed region, the method further comprises:
filtering an image through an image processing technology to remove noises of the image, wherein the image processing technology comprises any one of a median filtering, a mean filtering, a Gaussian filtering, or a bilateral filtering.

6. The Mura compensation method of claim 1, wherein the Gamma curve of the display panel is determined by using a following calculation formula:
$$L = ( {L}_{max} - {L}_{min} ) \times {( GL )}^{Gamma} + {L}_{min}$$
wherein, L is the luminance value of the display panel at grey scale being GL, Lₘₐₓ is the maximum luminance value of the display panel, Lₘᵢₙ is the minimum luminance value of the display panel.

7. A Mura compensation system of a display panel, wherein the Mura compensation system comprising:
an acquisition module configured for collecting a display image of the display panel and obtaining panel parameters of the display panel according to the display image, the panel parameters comprise a grey level and a luminance value of each pixel in the display image;
a processing module configured for removing a foreign object region in the display image and filling the removed region; and
a computing module configured for calculating the Gramma value of the display panel according to the panel parameters and determining a Gamma curve of the display panel;
wherein the processing module is further configured for obtaining a luminance value of each region of the display panel according to the Gamma curve;
the processing module is further configured for obtaining an ideal quadric surface for the display panel according to the luminance value of each region of the display panel;
the computing module is further configured for calculating a compensation parameter according to the quadric surface, and compensating the display panel according to the compensation parameter.

8. The Mura compensation system of claim 7, wherein the processing module is further configured for determining whether there exists foreign object in the display panel according to the panel parameter.

9. The Mura compensation system of claim 8, wherein the processing module is further configured for:
detecting the grey level of every sub-pixel of the display image;
comparing the grey level of every sub-pixel with the grey level of at least two adjacent sub-pixel;
determining whether the difference of the grey level between the sub-pixel and the at least two adjacent sub-pixel reaches a preset threshold, wherein
if the difference of the grey level between the sub-pixel and the at least two adjacent sub-pixel reaches the preset threshold value, the foreign object is determined to exist on the display panel; and
if the difference of the grey level between the sub-pixel and the at least two adjacent sub-pixel does not reach the preset threshold value, the foreign object is determined to not exist on the display panel.

10. The Mura compensation system of claim 7, wherein the processing module is further configured for:
obtaining an image edge of the foreign object image according to an edge detection algorithm;
obtaining a foreign object rectangular map by scanning the foreign object image according to a minimum enclosing rectangle algorithm;
removing the pixel in the foreign object rectangular map and obtaining a blank region;
compensating the blank region by a linear interpolation.

11. The Mura compensation system of claim 10, wherein the processing module is further configured for:
filtering an image through an image processing technology to remove noises of the image, wherein the image processing technology comprises any one of a median filtering, a mean filtering, a Gaussian filtering, or a bilateral filtering.

12. The Mura compensation system of claim 7, wherein the computing module is further configured for determining the Gamma curve of the display panel by using the following calculation formula:
$$L = ( {L}_{max} - {L}_{min} ) \times {( GL )}^{Gamma} + {L}_{min}$$
wherein, L is the luminance value of the display panel at grey scale being GL, Lₘₐₓ is the maximum luminance value of the display panel, Lₘᵢₙ is the minimum luminance value of the display panel.

13. An electronic device, the electronic device comprising a memory and at least one processor, the at least one processor storing multiple modules, the multiple modules executing by the at least one processor for:
collecting a display image of the display panel and obtaining panel parameters of the display panel according to the display image, the panel parameters comprise a grey level and a luminance value of each pixel in the display image;
removing a foreign object region in the display image and filling the removed region;
calculating a Gramma value of the display panel according to the panel parameters and determining a Gamma curve of the display panel;
obtaining a luminance value of each region of the display panel according to the Gamma curve;
obtaining an ideal quadric surface for the display panel according to the luminance value of each region of the display panel;
calculating a compensation parameter according to the quadric surface, and compensating the display panel according to the compensation parameter.

14. The electronic device of claim 13, wherein the at least one processor is further configured for determining whether there exists foreign object in the display panel according to the panel parameter.

15. The electronic device of claim 13, wherein the at least one processor is further configured for:
detecting the grey level of every sub-pixel of the display image;
comparing the grey level of every sub-pixel with the grey level of at least two adjacent sub-pixel;
determining whether the difference of the grey level between the sub-pixel and the at least two adjacent sub-pixel reaches a preset threshold, wherein
if the difference of the grey level between the sub-pixel and the at least two adjacent sub-pixel reaches the preset threshold value, the foreign object is determined to exist on the display panel; and
if the difference of the grey level between the sub-pixel and the at least two adjacent sub-pixel does not reach the preset threshold value, the foreign object is determined to not exist on the display panel.

16. The electronic device of claim 13, wherein the at least one processor is further configured for:
obtaining an image edge of the foreign object image according to an edge detection algorithm;
obtaining a foreign object rectangular map by scanning the foreign object image according to a minimum enclosing rectangle algorithm;
removing the pixel in the foreign object rectangular map and obtaining a blank region;
compensating the blank region by a linear interpolation.

17. The electronic device of claim 16, wherein the at least one processor is further configured for:
filtering an image through an image processing technology to remove noises of the image, wherein the image processing technology comprises any one of a median filtering, a mean filtering, a Gaussian filtering, or a bilateral filtering.

18. The electronic device of claim 13, wherein the at least one processor is further configured for determining the Gamma curve of the display panel by using the following calculation formula:
$$L = ( {L}_{max} - {L}_{min} ) \times {( GL )}^{Gamma} + {L}_{min}$$
wherein, L is the luminance value of the display panel at grey scale being GL, Lₘₐₓ is the maximum luminance value of the display panel, Lₘᵢₙ is the minimum luminance value of the display panel.
